(19) United States
(12) Patent Application Publication
(10) Pub. No.: US 2026/0074505 A1
(43) Pub. Date: Mar. 12, 2026

(54) PROTECTION SWITCH

(71) Applicant: STMicroelectronics International N.V., Geneva (CH)

(72) Inventor: Karl GRANGE, Tours (FR)

(21) Appl. No.: 19/310,379

(22) Filed: Aug. 26, 2025

(30) Foreign Application Priority Data
Sep. 9, 2024 (FR) 2409526

(51) Int. Cl. H02H 3/10

(52) U.S. Cl. CPC H02H 3/10

(57) ABSTRACT

The present disclosure relates to a switch for protecting against overvoltage and overcurrent, comprising: a first NMOS-type transistor suitable for receiving across its conduction terminals a first voltage; a second NMOS-type transistor comprising a source terminal coupled to a source terminal of the first transistor, and being suitable for receiving across its conduction terminals a second voltage less than the first voltage; and a third NMOS-type transistor comprising a source terminal coupled to a source terminal of the first transistor, and being suitable for receiving across its conduction terminals the second voltage.

### CROSS REFERENCE TO RELATED APPLICATIONS

This application claims the priority benefit of French Patent Application Number FR2409526, filed on Sep. 9, 2024, entitled “Interrupteur de protection”, which is hereby incorporated by reference to the maximum extent allowable by law.

### TECHNICAL FIELD

The present description relates generally to electronic systems and devices, and more specifically to the protection of electronic systems and devices against spurious phenomena such as overvoltage or overcurrent occurrences.

### BACKGROUND

Overvoltage or overcurrent occurrences within an electronic system or device may prevent its proper operating and may even deteriorate the same.

It would be desirable to be able to improve at least in part some aspects of the known devices for protecting against overvoltage and overcurrent occurrences.

### BRIEF SUMMARY

There is a need for more efficient devices for protecting against overvoltage and overcurrent.

There is a need for more efficient switches for protecting against overvoltage and overcurrent.

There is a need for switches for protecting against overvoltage and overcurrent being more compatible with the to-be-protected device.

There is a need for switches for protecting against overvoltage and overcurrent able to more precisely detect overcurrent.

There is a need for switches for protecting against overvoltage and overcurrent having smaller dimensions.

One embodiment overcomes all or some of the drawbacks of known switches for protecting against overvoltage and overcurrent.

One embodiment overcomes all or some of the drawbacks of known devices for protecting against overvoltage and overcurrent.

One embodiment provides a switch for protecting against overvoltage and overcurrent, comprising: a first NMOS-type transistor suitable for receiving across its conduction terminals a first voltage; a second NMOS-type transistor comprising a source terminal coupled to a source terminal of the first transistor, and being suitable for receiving across its conduction terminals a second voltage less than the first voltage; and a third NMOS-type transistor comprising a source terminal coupled to a source terminal of the first transistor, and being suitable for receiving across its conduction terminals the second voltage.

According to an embodiment, the second and third transistors operate in reverse ohmic mode.

According to an embodiment, the first voltage ranges from 5 to 65 V.

According to an embodiment, the second voltage ranges from 5 to 8 V.

According to an embodiment, the switch further comprises: a fourth NMOS-type transistor suitable for receiving across its conduction terminals the first voltage; a fifth NMOS-type transistor comprising a source terminal coupled to a source terminal of the fourth transistor, and being suitable for receiving across its conduction terminals the second voltage; and a sixth NMOS-type transistor comprising a source terminal coupled to a source terminal of the fourth transistor, and being suitable for receiving across its conduction terminals the second voltage.

According to an embodiment, the switch further comprises a controllable voltage source, and a managing circuit of the controllable voltage source, the controllable voltage source being suitable to supply a voltage between the source terminal of the second transistor and the gate terminal of the second transistor, and between the source terminal of the third transistor and the gate terminal of the third transistor.

Another embodiment provides a device for protecting against overvoltage and overcurrent, comprising a switch previously described.

Another embodiment provides a device according to claim 7, further comprising a control circuit of the switch.

According to an embodiment, the device further comprises an overcurrent detection circuit coupled to a drain terminal of the third transistor.

According to an embodiment, the overcurrent detection circuit comprises an inner-voltage compensation circuit.

According to an embodiment, the device further comprises an overvoltage detection circuit coupled to a drain terminal of the first transistor.

Another embodiment provides an electronic device comprising a device for protecting against overvoltage and overcurrent previously described.

Another embodiment provides a power charge device comprising a device for protecting against overvoltage and overcurrent previously described.

Another embodiment provides an electronic system comprising an electronic device, a power charge device, and a device for protecting against overvoltage and overcurrent previously described.

Another embodiment provides a method for protecting against overvoltage and overcurrent using a switch previously described.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 illustrates an embodiment of an electronic system;

FIG. 2 illustrates an embodiment of a device for protecting against overvoltage and overcurrent;

FIG. 3 illustrates a curve showing the operation of a MOS transistor;

FIG. 4 illustrates another embodiment of a device for protecting against overvoltage and overcurrent; and

FIG. 5 illustrates another embodiment of a device for protecting against overcurrent.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to a . . . as orientated during normal use.

Unless specified otherwise, the expressions “around”, “approximately”, “substantially” and “in the order of” signify within 10 %, and preferably within 5 %.

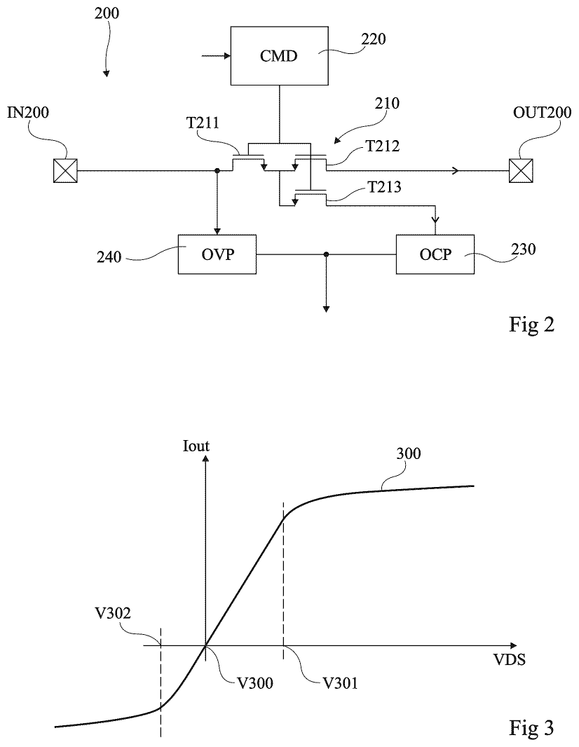

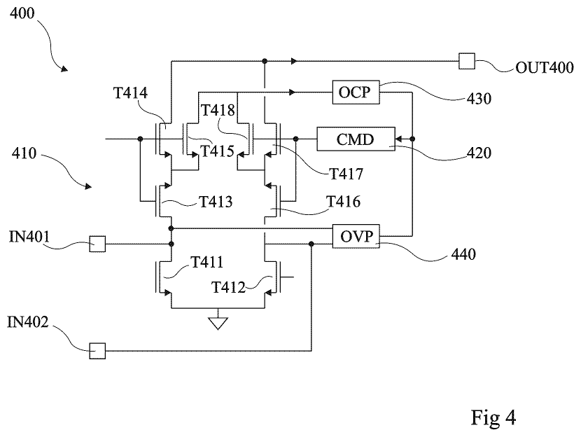

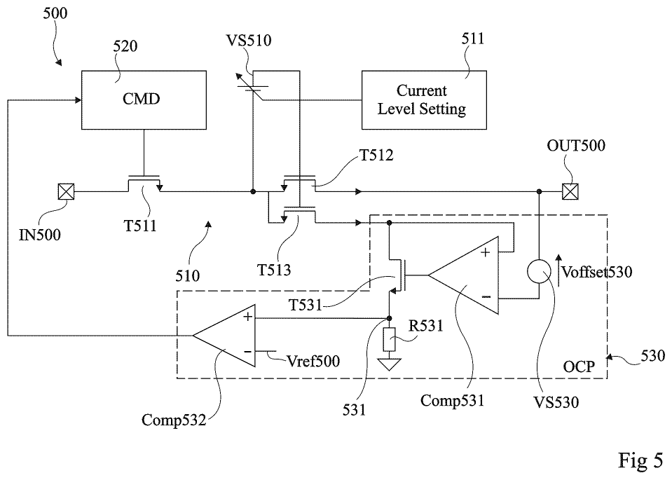

The embodiments hereinafter described relate to protecting devices against overvoltage and overcurrent, and more particularly concern a switch for protecting against such phenomena. This switch comprises a first high voltage transistor suitable for receiving overvoltage, and second low voltage transistors suitable for detecting overcurrent. The structure of this switch will be described in detail in reference to FIGS. 2 and 3, and allows to free from the use of a high-voltage transistor suitable for detecting overcurrent. Alternatives of this structure will be described in detail in reference to FIGS. 4 and 5.

In addition, the hereinafter described embodiments are particularly suitable for being used in any type of industrial markets where a protection against overvoltage and overcurrent is required. More particularly, such a protection switch could be intended to: the automotive industry, for example in the field of automotive electrification, or in the field of Advanced Driver Assistance Systems (ADAS); the industrial industry, for example in the field of green energy, in the field of infrastructure electrification, of Internet of Things (IoT), and of Smart Home, wherein the power and electrical consumption and data exchange are key elements; the personal electronic industry, for example in the field of mobile phone and of Internet of Things (IoT), as well as in the field of high-speed interfaces; and the industry of communications equipment, of computers, and of peripherals, for example in the field of infrastructures and of Data Centers, and in the field of Low Earth Orbit (LEO) satellites.

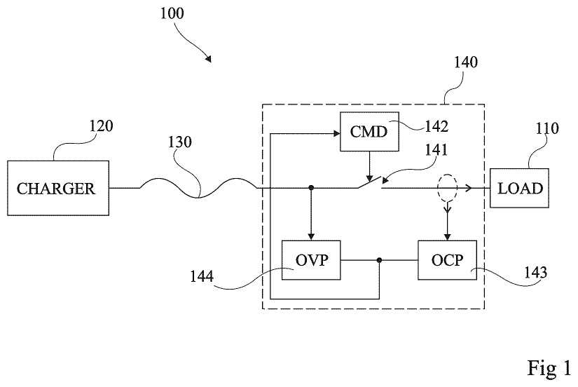

FIG. 1 illustrates very schematically and in block form, an embodiment of an electronic system 100.

The electronic system 100 comprises an electronic device 110 (LOAD) comprising means of power distribution, such as a battery, which could need to be charged. To this end, the system 100 further comprises a power charge device 120 (CHARGER) suitable for charging the means of power distribution of the electronic device 110. The device 110 could also be referred to as to-be-protected device.

System 100 further comprises electric connection means 130 of the devices 110 and 120. According to one embodiment, means 130 is suitable for transmitting power, and if applicable, data, from the device 120 to the device 110. According to an example, means 130 is a wire. Means 130 can handle any type of protocol for transmitting power and, if applicable, for transmitting data. According to an example, means 130 could also be used as means of transmission of power and, if applicable, data, from the device 110 to the device 120.

According to one embodiment, system 100 further comprises a device for protecting against overvoltage and overcurrent 140 allowing the device 110 to be protected against overvoltage and overcurrent. Several embodiments of devices for protecting against overvoltage and overcurrent will be described in reference to FIGS. 2 to 5.

In FIG. 1, the protection device 140 is illustrated as disposed between means 130 and the device 110, but as an alternative, the device 140 could be part of, i.e. integrated within, device 110, charging device 120, or means 130.

According to one embodiment, the protection device 140 comprises: a protection switch 141; a control circuit 142 (CMD) of the switch 141; an overcurrent detection circuit 143 (OCP); and an overvoltage detection circuit 144 (OVP).

According to one embodiment, the switch 141 is disposed so as to interrupt the power supply of the device 110 by the device 120 in a case where an overvoltage and/or overcurrent is detected. In other words, the switch 141 is disposed so as to disconnect the device 110 from the device 120 in the case where an overvoltage and/or overcurrent is detected. In the following, the terminal of the switch 141 coupled to the device 120 is referred to as input of the switch 141, and the terminal of the switch 141 coupled to the device 110 is referred to as output of the switch 141. Detailed examples of the switch 141 will be described in reference to FIGS. 2, 4, and 5.

According to one embodiment, the control circuit 142 is suitable for receiving information from the detection circuits 143 and 144, and for applying a control to the switch 141 depending on this information. More particularly, if the control circuit receives from the detection circuits 143 and 144 an information indicating that an overvoltage or overcurrent is detected, the control circuit 142 then sends a switching-OFF control to the switch 141 that then turns non-conductive.

According to one embodiment, the overcurrent detection circuit 143 is coupled, preferably connected, to the output of the switch 141, i.e. between the switch 141 and the device 110. A detailed example of the circuit 143 will be described in reference to FIG. 5.

According to one embodiment, the overvoltage detection circuit 144 is coupled, preferably connected, to the input of the switch 141, i.e. between the switch 141 and the device 120.

One implementation mode of a method for protecting against overvoltage and overcurrent is as follows. Upon detection of an overcurrent by the detection device 143, an information is sent to the control circuit 142, which then transmits a control to switch OFF the switch 141 thus disconnecting the device 110 from the device 120. Upon detection of an overvoltage by the detection device 144, an information is sent to the control circuit 142, which then transmits a control to switch OFF the switch 141 thus disconnecting the device 110 from the device 120. When no overvoltage and no overcurrent is detected, the switch 141 is conductive.

FIG. 2 illustrates schematically and partly in block form one embodiment of a device for protecting against overvoltage and overcurrent 200.

The protection device 200 is similar to the protection device 140 described in reference to FIG. 1. The features that are common to the devices 140 and 200 are not again described in detail. Only the differences among the devices 140 and 200 are highlighted.

Thus, like device 140, device 200 comprises: a protection switch 210 of the type of the protection switch 141; a control circuit 220 (CMD) of the switch 210 of the type of the control circuit 142; an overcurrent detection circuit 230 (OCP) of the type of the overcurrent detection circuit 143; and an overvoltage detection circuit 240 (OVP) of the type of the overvoltage detection circuit 144.

According to an example, the device 200 comprises an input terminal IN200 suitable for being coupled to a device of the type of the device 120 described in reference to FIG. 1. According to an example, the device 200 further comprises an output terminal OUT200 suitable for being coupled to a device of the type of the device 110 described in reference to FIG. 1.

According to one embodiment, the switch 210 comprises a first transistor T211. According to an example, transistor T211 is a metal-oxide-semiconductor field-effect transistor, or MOSFET transistor, or MOS transistor. In addition, transistor T211 is an N-channel MOS transistor, or N-type MOS transistor, or NMOS transistor. Furthermore, transistor T211 is suitable for receiving high voltages across its conduction terminals, i.e., its source and drain terminals. More particularly, transistor T211 is suitable for receiving across its conduction terminals, a maximum voltage ranging from 5 to 65 V, for example greater than 10 or 12 V, for example in the order of 16 V.

According to one embodiment, the switch 210 further comprises two transistors T212 and T213. According to an example, transistors T211 and T212 are NMOS transistors. Furthermore, transistors T212 and T213 are suitable for receiving low voltages across their conduction terminals. In other words, transistors T212 and T213 are suitable for receiving, across their conduction terminals, a maximum voltage less than the maximum voltage the transistor T21 is able to withstand. More particularly, transistors T212 and T213 are suitable for receiving, across their conduction terminals, a voltage ranging from 5 to 8 V, for example in the order of 5 V.

According to one embodiment, a drain terminal of the transistor T211 is coupled, preferably connected, to the input terminal IN200 of the device 200, and a source terminal of the terminal T211 is coupled, preferably connected, to the source terminals of transistors T212 and T213. According to one embodiment, a drain terminal of the transistor T212 is coupled, preferably connected, to the output terminal OUT200 of the device 200. According to one embodiment, a drain terminal of the transistor T213 is coupled, preferably connected, to the input terminal of the overcurrent detection circuit 230. According to one embodiment, gate terminals of transistors T211, T212, and T213 all are coupled, preferably connected, to an output of the control circuit 220.

Transistor T211 is used as power switch allowing the to-be-protected device to be disconnected from the charge device when an overvoltage or overcurrent is detected. Transistor T212 is used as conduction transistor allowing power to be conducted to the to-be-protected device. Transistor T213 is used as current-measurement transistor since it transmits a part of the current received by the to-be-protected device to the overcurrent detection circuit 230. According to one embodiment, for a correct operation of the switch 210, transistors T212 and T213 operate in reverse ohmic mode. This mode will be described in detail in reference to FIG. 3. The control circuit 200 is thus suitable for providing transistors T212 and T213 with a control allowing the same to operate in reverse ohmic mode.

One advantage of the switch 210 lays in that it has a smaller footprint with respect to already-existing protection switches. Indeed, it is common to use two high voltage transistors to form a transistor for protecting against overvoltage and overcurrent. High voltage transistors generally have a higher surface area as compared to low voltage transistors. Using a single high power transistor and two low voltage transistors allows the footprint of the switch 210 to be reduced.

FIG. 3 illustrates a curve 300 showing an operation characteristic of an NMOS-type transistor. More particularly, curve 300 shows the evolution of the output current Iout delivered at the source terminal of an NMOS transistor as a function of the voltage VDS across its conduction terminals.

When the voltage VDS is positive, and more specifically ranges from a zero voltage V300 to a saturation voltage V301, the transistor operates in ohmic mode. In other words, in such case, the transistor can be considered as resistor.

When the voltage VDS exceeds the saturation voltage V301, the transistor operates in a saturation mode. In other words, its output current Iout increases slower and slower to reach a step.

When the voltage VDS is negative, and more specifically ranges from the zero voltage V300 to a reverse saturation voltage V302, the transistor operates in reverse ohmic mode. In other words, in such case, the transistor can be still considered as a resistor until the reverse saturation voltage V302.

When the current Iout exceeds the reverse saturation current I302, the transistor operates in a reverse saturation mode. In other words, the transistor operates as a diode.

FIG. 4 illustrates schematically and partly in block form, another embodiment of a device for protecting against overvoltage and overcurrent 400.

Protection device 400 is similar to the protection device 140 described in reference to FIG. 1, and to the protection device 200 described in reference to FIG. 2. The features that are common among devices 140, 200, and 400 are not again described in detail. Only the differences among devices 140, 200, and 400 are highlighted.

Thus, like device 200, device 400 comprises: a protection switch 410 of the type of the protection switch 210; a control circuit 420 (CMD) of the switch 410 of the type of the control circuit 220; an overcurrent detection circuit 430 (OCP) of the type of the overcurrent detection circuit 230; and an overvoltage detection circuit 440 (OVP) of the type of the overvoltage detection circuit 240.

Device 400 differs from device 200 in that it comprises two input terminals IN401 and IN402, and in that it thus comprises a dual protection switch 410. Device 400 comprises a single output terminal OUT400.

According to one embodiment, the protection switch 410 comprises two NMOS transistors T411 and T412 suitable for receiving high voltages, i.e., of the type of transistor T211. A source terminal of the transistor T411 is coupled, preferably connected, to a source terminal of transistor T412, and to a node receiving a reference potential, for example ground. A drain terminal of the transistor T411 is coupled, preferably connected, to the input terminal IN401, and to an input of the overvoltage detection circuit 440. A drain terminal of the transistor T412 is coupled, preferably connected, to the input terminal IN402, and to another input of the overvoltage detection circuit 440. The gate terminals of transistors T411 and T412 are coupled, preferably connected, to outputs (not shown in FIG. 4) of the control circuit 420.

According to one embodiment, the protection switch 410 further comprises three NMOS transistors T413, T414, and T415 forming a structure of the type of the structure of the switch 210 described in reference to FIG. 2. More particularly, the transistor T413 is suitable for receiving high voltages, i.e., is of the type of transistor T211, and transistors T414 and T415 are suitable for receiving low voltages, i.e., are of the type of transistors T212 and T213.

According to one embodiment, a drain terminal of the transistor T413 is coupled, preferably connected, to the input terminal IN401 of the device 400, and a source terminal of the transistor T413 is coupled, preferably connected, to the source terminals of transistors T414 and T415. According to one embodiment, a drain terminal of the transistor T414 is coupled, preferably connected, to the output terminal OUT400 of the device 400. According to one embodiment, a drain terminal of the transistor T415 is coupled, preferably connected, to an input of the overcurrent detection circuit 430. According to one embodiment, the gate terminals of the transistors T413, T414, and T415 all are coupled, preferably connected, to an output of the control circuit 420.

According to one embodiment, the protection switch 410 further comprises three other NMOS transistors T416, T417, and T418 forming a structure of the type of the structure of the switch 210 described in reference to FIG. 2. More particularly, the transistor T416 is suitable for receiving high voltages, i.e., is of the type of transistor T211, and transistors T417 and T418 are suitable for receiving low voltages, i.e., are of the type of transistors T212 and T213.

According to one embodiment, a drain terminal of the transistor T416 is coupled, preferably connected, to the input terminal IN402 of the device 400, and a source terminal of the transistor T416 is coupled, preferably connected, to the source terminals of transistors T417 and T418. According to one embodiment, a drain terminal of the transistor T417 is coupled, preferably connected, to the output terminal OUT400 of the device 400. According to one embodiment, a drain terminal of the transistor T418 is coupled, preferably connected, to an input of the overcurrent detection circuit 430. According to one embodiment, the gate terminals of the transistors T416, T417, and T418 all are coupled, preferably connected, to an output of the control circuit 420.

As that was described in reference to FIGS. 2 and 3, transistors T414, T415, T416, T417, and T418 all are controlled to operate in reverse ohmic mode.

An advantage of this device lays in that it allows overvoltage and overcurrent to be detected on two input terminals.

Furthermore, it is within the capabilities of those skilled in the art to generalize the embodiment described in reference to FIG. 4 to a device for protecting against overvoltage and overcurrent comprising more than two inputs.

FIG. 5 illustrates schematically and partly in block form another embodiment of a device 500 for protecting against overvoltage and overcurrent.

The protection device 500 is similar to the protection device 140 described in reference to FIG. 1, and to the protection device 200 described in reference to FIG. 2. The features that are common among devices 140, 200, and 500 are not again described in detail. Only the differences among devices 140, 200, and 500 are highlighted.

Thus, like device 200, device 500 comprises: a protection switch 510 of the type of the protection switch 210; a control circuit 520 (CMD) of the switch 510 of the type of the control circuit 220; an overcurrent detection circuit 530 (OCP) of the type of the overcurrent detection circuit 230; and according to an example, an overvoltage detection circuit of the type of the overvoltage detection circuit 240 (not shown in FIG. 5).

Device 500 differs from device 200 in that switch 510 is suitable for filtering overcurrent occurring at input terminals.

According to one embodiment, the protection switch 510 further comprises three NMOS transistors T511, T512, and T513 forming a structure of the type of the structure of the switch 210 described in reference to FIG. 2. More particularly, the transistor T511 is suitable for receiving high voltages, i.e., is of the type of transistor T211, and transistors T512 and T513 are suitable for receiving low voltages, i.e., are of the type of transistors T212 and T213.

According to one embodiment, a drain terminal of the transistor T511 is coupled, preferably connected, to the input terminal IN501 of the device 500, and a source terminal of the transistor T511 is coupled, preferably connected, to the source terminals of transistors T512 and T513. According to one embodiment, a drain terminal of the transistor T512 is coupled, preferably connected, to an output terminal OUT500 of the device 500. According to one embodiment, a drain terminal of the transistor T513 is coupled, preferably connected, to an input of the overcurrent detection circuit 530. According to one embodiment, the gate terminal of the transistor T513 is coupled, preferably connected, to an output of the control circuit 520.

According to one embodiment, switch 510 further comprises a controllable voltage source VS510, and a managing circuit 511 (Current Level Setting) of the controllable voltage source VS510. The voltage source is suitable for providing transistors T512 and T513 with a control potential, and for adjusting this control potential according to the value of the current transmitted across the terminals IN500 and OUT500.

In addition, according to an example, the overcurrent detection circuit could comprise: an NMOS transistor T531; two comparators Comp531 and Comp532; a resistor T531; and an inner-voltage compensation circuit (VS530) of the comparator.

According to an example, a drain terminal of the transistor T531 is coupled, preferably connected, to the drain terminal of the device T513, and a source terminal of the transistor T531 is coupled, preferably connected, to a node 531. A gate terminal of the transistor T531 is coupled, preferably connected, to an output of comparator Comp531. A first terminal of resistor R531 is coupled, preferably connected, to node 531, and a second terminal of resistor R531 is coupled, preferably connected, to a node providing a reference potential, such as the ground. A non-inverting terminal (+) of the comparator is coupled, preferably connected, to node 531, and an inverting terminal (−) is coupled to the output terminal OUT500 of the device 500 via circuit VS530. According to an example, the circuit VS530 is a voltage source providing a voltage Voffset230 compensating for an inner offset voltage of the comparator Comp530. The comparator Comp531 and the transistor form a conversion stage of the current provided by the transistor T513 into a voltage.

According to an example, the comparator Comp532 is used to compare the voltage provided by the conversion stage with a reference voltage Vref500. It is a stage for detecting an overcurrent. For this, a non-inverting terminal (+) of the comparator Comp532 is coupled, preferably connected, to the source terminal of the transistor T531. An inverting terminal (−) of the comparator Comp532 is adapted to receive the reference voltage Vref500. An output of the comparator Comp532 is coupled, preferably connected, to the control circuit 520.

One implementation mode of a method for protecting against overvoltage and overcurrent is as follows. Upon detection of an overcurrent by the detection device 530, an information is sent to the circuit 511, which then transmits a control to adapt the switching OFF of the switches T512 and T513 thus disconnecting the to-be-protected device from the charge device. Upon detection of an overvoltage by the overvoltage detection device (not shown in FIG. 5), an information is sent to the control circuit 520, which then transmits a control to switch OFF the switch T511 thus disconnecting the to-be-protected device from the charge device.

An advantage of this embodiment is that it allows to compensate the offset voltage Voffset530 of the comparator Comp531. Indeed, this voltage Voffset is constant but the current that it provides is dependent on the resistance in the ON state of the transistor T513. The smaller this resistance, the smaller the current resulting from the voltage Voffset, it is therefore sufficient to vary the resistance of the transistor T513 to vary the error of the overcurrent detection circuit.

Various embodiments and variants have been described. Those skilled in the art will understand that certain features of these embodiments can be combined and other variants will readily occur to those skilled in the art. In particular, the embodiments described in reference to FIGS. 4 and 5 could be combined without any significant inventive effort.

Finally, the practical implementation of the embodiments and variants described herein is within the capabilities of those skilled in the art based on the functional description provided hereinabove. That which is claimed:

1. A switch for protecting against overvoltage and overcurrent, comprising:
a first N-channel metal-oxide-semiconductor (NMOS)-type transistor suitable for receiving across its conduction terminals a first voltage;
a second NMOS-type transistor comprising a source terminal coupled to a source terminal of the first transistor, and being suitable for receiving across its conduction terminals a second voltage less than the first voltage; and
a third NMOS-type transistor comprising a source terminal coupled to a source terminal of the first transistor, and being suitable for receiving across its conduction terminals the second voltage.

2. The switch according to claim 1, wherein the second and third transistors operate in reverse ohmic mode.

3. The switch according to claim 1, wherein the first voltage ranges from 5 to 65 volts (V); and
wherein the second voltage ranges from 5 to 8 V.

4. The switch according to claim 1, further comprising:
a fourth NMOS-type transistor suitable for receiving across its conduction terminals the first voltage;
a fifth NMOS-type transistor comprising a source terminal coupled to a source terminal of the fourth transistor, and being suitable for receiving across its conduction terminals the second voltage; and
a sixth NMOS-type transistor comprising a source terminal coupled to a source terminal of the fourth transistor, and being suitable for receiving across its conduction terminals the second voltage.

5. The switch according to claim 1, further comprising a controllable voltage source, and a managing circuit of the controllable voltage source, the controllable voltage source being suitable to supply a voltage between the source terminal of the second transistor and a gate terminal of the second transistor, and between the source terminal of the third transistor and a gate terminal of the third transistor.

6. A device for protecting against overvoltage and overcurrent, comprising:
a switch comprising:
a first N-channel metal-oxide-semiconductor (NMOS)-type transistor suitable for receiving across its conduction terminals a first voltage;
a second NMOS-type transistor comprising a source terminal coupled to a source terminal of the first transistor, and being suitable for receiving across its conduction terminals a second voltage less than the first voltage; and
a third NMOS-type transistor comprising a source terminal coupled to a source terminal of the first transistor, and being suitable for receiving across its conduction terminals the second voltage.

7. The device according to claim 6, wherein the second and third transistors of the switch operate in reverse ohmic mode.

8. The device according to claim 6, wherein the first voltage of the switch ranges from 5 to 65 volts (V); and
wherein the second voltage of the switch ranges from 5 to 8 V.

9. The device according to claim 6, wherein the switch further comprises:
a fourth NMOS-type transistor suitable for receiving across its conduction terminals the first voltage;
a fifth NMOS-type transistor comprising a source terminal coupled to a source terminal of the fourth transistor, and being suitable for receiving across its conduction terminals the second voltage; and
a sixth NMOS-type transistor comprising a source terminal coupled to a source terminal of the fourth transistor, and being suitable for receiving across its conduction terminals the second voltage.

10. The device according to claim 6, wherein the switch further comprises:
a controllable voltage source; and
a managing circuit of the controllable voltage source;
wherein the controllable voltage source is suitable to supply a voltage between the source terminal of the second transistor and a gate terminal of the second transistor of the switch, and between the source terminal of the third transistor and a gate terminal of the third transistor of the switch.

11. The device according to claim 6, further comprising a control circuit of the switch.

12. The device according to claim 6, further comprising an overcurrent detection circuit coupled to a drain terminal of the third transistor of the switch.

13. The device according to claim 12, wherein the overcurrent detection circuit comprises an inner-voltage compensation circuit.

14. The device according to claim 6, further comprising an overvoltage detection circuit coupled to a drain terminal of the first transistor of the switch.

15. An electronic system comprising:
an electronic device;
a power charge device; and
a device for protecting against overvoltage and overcurrent comprising:
a switch comprising:
a first N-channel metal-oxide-semiconductor (NMOS)-type transistor suitable for receiving across its conduction terminals a first voltage;
a second NMOS-type transistor comprising a source terminal coupled to a source terminal of the first transistor, and being suitable for receiving across its conduction terminals a second voltage less than the first voltage; and
a third NMOS-type transistor comprising a source terminal coupled to a source terminal of the first transistor, and being suitable for receiving across its conduction terminals the second voltage.

16. The system according to claim 15, wherein the second and third transistors of the switch of the device for protecting against overvoltage and overcurrent operate in reverse ohmic mode.

17. The system according to claim 15, wherein the switch of the device for protecting against overvoltage and overcurrent further comprises:
a fourth NMOS-type transistor suitable for receiving across its conduction terminals the first voltage;
a fifth NMOS-type transistor comprising a source terminal coupled to a source terminal of the fourth transistor, and being suitable for receiving across its conduction terminals the second voltage; and
a sixth NMOS-type transistor comprising a source terminal coupled to a source terminal of the fourth transistor, and being suitable for receiving across its conduction terminals the second voltage.

18. The system according to claim 15, wherein the switch of the device for protecting against overvoltage and overcurrent further comprises:
a controllable voltage source; and
a managing circuit of the controllable voltage source;
wherein the controllable voltage source is suitable to supply a voltage between the source terminal of the second transistor and a gate terminal of the second transistor of the switch, and between the source terminal of the third transistor and a gate terminal of the third transistor of the switch.

19. The device according to claim 15, further comprising an overcurrent detection circuit coupled to a drain terminal of the third transistor of the switch of the device for protecting against overvoltage and overcurrent; and
an overvoltage detection circuit coupled to a drain terminal of the first transistor of the switch of the device for protecting against overvoltage and overcurrent.

20. The device according to claim 19, wherein the overcurrent detection circuit comprise an inner-voltage compensation circuit.
